(19) United States
(12) Patent Application Publication
(10) Pub. No.: US 2015/0318815 A1
(43) Pub. Date: Nov. 5, 2015

(54) COMBUSTION, HEAT-EXCHANGE AND EMITTER DEVICE

(71) Applicant: TRIANGLE RESOURCE HOLDING (SWITZERLAND) AG, Zug (CH)

(72) Inventors: Reto Holzner, Zurich (CH); Urs Weidmann, Cham (CH)

(21) Appl. No.: 14/648,926

(22) PCT Filed: Dec. 5, 2013
(86) PCT No.: PCT/EP2013/075717

§ 371 Date: Jun. 2, 2015

(30) Foreign Application Priority Data
Dec. 5, 2012 (EP) 12195732.8

(51) Int. Cl. H02S 10/30; B23P 15/00; F24C 3/04

(52) U.S. Cl. CPC H02S 10/30; F24C 3/04; B23P 15/00

(57) ABSTRACT

A combustion, heat-exchange and emitter device (10) for converting chemicals into electro-magnetic radiation and a corresponding method. The device (10) includes a radiation emission section (A) with a selective emitter (1.3) configured for emitting predominantly near-infrared radiation when heated up to high temperatures. A conversion section (B) is arranged adjacent to the radiation emission section (A) and includes a catalytic coating in order to provide for surface specific fuel combustion to maximize heat transfer between a thermal energy carrier (fuel) and the radiation emission section (A). A heat recovery section (F) is configured to transfer excess heat of the thermal energy carrier from an exhaust outlet section (G) to an inlet section (E) to pre-heat the thermal energy carrier (fuel) entering the device (10) therethrough.

### FIELD OF THE INVENTION

The present invention relates to a combustion, heat-exchange and emitter device, a method for providing such and a thermophotovoltaic device comprising the same.

### BACKGROUND OF THE INVENTION

With the high demand of electricity and even more of clean, CO₂ neutral energy sources, the efficiency with which the energy is harvested plays a more and more important role. As gradually many industrialized countries aim for shifting away from nuclear power production, the demand for alternative energy sources is greater than ever. However, so far few if any really viable alternatives are known. Many of the “classical” renewable energy sources such as wind-turbines or solar power plants have significant drawbacks preventing their wide-spreading.

Still, even if these drawbacks of “classical” renewable energy sources such as wind-turbines or solar power plants would be solved, there is still the major problem that quite often these sources of renewable energy are available at a very different locations than where the electrical energy is needed. The great distances between the generation location and the energy consumers require very complex, expensive and environmentally unfriendly infrastructure to transport the produced electrical energy. Furthermore, regardless of the improvements of such infrastructures in the latest period, there are still significant losses in the transport of electrical energy over long distances. Therefore there is an urgent need for decentralized energy production. In other words, the future of energy production lies in producing energy as close as possible to the consumer. This not only reduces/eliminates transmission losses but relives the electrical grid while ensuring much higher levels of flexibility.

One of the fields of great interest for decentralized energy production is the field of thermophotovoltaic devices, devices designed to transform chemical energy stored in a fuel into electro-magnetic radiation and then into electricity. However, the relatively reduced efficiency of the existing thermophotovoltaic devices has limited their use and mass-deployment.

As for efficiency, one of the most problematic aspect of these chemical-to-electric energy converters is the inefficiency of the conversion of chemical energy into electro-magnetic radiation. A critical component of the chemical-to-electric energy conversion is the combustion, heat-exchange and emitter device which transforms chemical energy into radiation. Combustion, heat exchange and emitter can be realised either separately or in one combined device, the latter having the advantage of reduced losses and compactness.

Various heat-exchange and emitter devices are known in the art aimed at improving their efficiency by loss heat recovery of the exhaust gases or by using emitters with high efficiency in the desired spectral band. However, known heat-exchange and emitter devices are complex and expensive to manufacture.

### Technical Problem to be Solved

Irrespective of the type and construction of the thermophotovoltaic devices, an efficient heat transfer to the emitter and efficient transformation of this heat into electromagnetic radiation of optimal wavelength is desired.

The objective of the present invention is thus to provide a heat exchanger and emitter structure which enables a highly efficient transfer of heat and its transformation into electromagnetic radiation suitable for conversion into electrical energy. In addition to providing high efficiency, it is an objective of the present invention to simplify and thus reduce the manufacturing costs of such heat exchanger and emitters.

### SUMMARY OF THE INVENTION

The above-identified objectives of the present invention are solved by a combustion, heat-exchange and emitter device for converting chemical into electro-magnetic radiation, the device comprising:

a radiation emitter section comprising a selective emitter configured for emitting predominantly near-infrared radiation when heated up to high temperatures;

a conversion section arranged adjacent to said radiation emitter section and comprising a catalytic coating in order to provide for surface specific fuel combustion to maximize heat transfer between a thermal energy carrier and the radiation emitter section;

a heat recovery section configured such as to transfer excess heat of the thermal energy carrier from an exhaust outlet section to an inlet section such as to pre-heat the thermal energy carrier (fuel) entering the device therethrough.

The above-identified objectives of the present invention are further solved by a method for producing a combustion, heat-exchange and emitter device in a layered fashion, the method comprising the steps:

providing an emitter layer having an outer surface facing away from the combustion, heat-exchange and emitter device and an inner surface;

at least partially coating said inner surface of the emitter layer with e.g. a catalytic coating in order to provide for surface specific fuel combustion;

providing said emitter layer with a selective emitter configured for emitting predominantly near-infrared radiation in the direction of said outer surface when it is heated up to high temperatures via said inner surface;

providing a pre-heat layer;

joining said emitter layer with the pre-heat layer such as to define a combustion chamber adjacent to the inner surface of the emitter layer;

providing a heat conduction layer with a heat dissipating surface and a heat absorbing surface;

joining the pre-heat layer and the heat conduction layer, such as to define a pre-heat chamber in-between and thermally connect the pre-heat chamber to said heat dissipating surface;

providing a first flow-through passage connecting the pre-heat chamber with the combustion chamber;

providing a heat conduction inhibition layer;

joining said heat conduction inhibition layer with the heat conduction layer such as to define a heat recovery chamber adjacent to said heat absorbing surface; and

providing a second flow-through passage connecting the combustion chamber and the heat recovery chamber,

the heat recovery chamber and the pre-heat chamber being arranged and configured such that heat absorbed by the heat absorbing surface is dissipated by the heat dissipating surface such as to pre-heat a thermal energy carrier within the pre-heat chamber.

### Advantageous Effects

The separation of the particular functions of a combustion, heat-exchange and emitter into well-defined sections allows each section to be fully optimised for the specific function. Thus the radiation emitter section is produced such as to provide optimum emission in the desired spectral band; the conversion section is optimised to provide for surface specific fuel combustion to maximize heat transfer between a thermal energy carrier (fuel) and the radiation emitter section; whereas the heat recovery section is optimised for maximizing heat recovery from the exhaust gases. Separating the functions into well-defined sections also allows each section to be produced of materials with properties suitable for the specific function.

Furthermore, the separation of the sections allows each section to be produced to an appropriate standard, enabling a particularly cost-effective production of the combustion, heat-exchange and emitter device by providing the option to produce the most technologically demanding and thus costly section (i.e. radiation emitter section comprising a selective emitter) separately from the other sections.

A particularly preferred method of producing the heat-exchange and emitter device of the present invention in a layered manner allows the emitter layer being produced and coated with a catalytic coating separately from the other layers. As the manufacturing requirements for the emitter layer and coating are much stricter, the process is much more elaborate and the technology much more expensive, by producing all other layers separately (in less demanding and thus less expensive production environments) provides for an essentially improved cost-effectiveness. Separating the production of “high-precision/high-tech” components also allows for an increase in productivity as not all components must be produced according to the same strict standards.

### INDUSTRIAL APPLICABILITY

The combustion, heat-exchange and emitter device of the present invention finds particularly advantageous applicability for example in:
A thermophotovoltaic device comprising a photovoltaic cell arranged adjacent to the combustion, heat-exchange and emitter device in a radiating direction of its selective emitter used for producing electric energy;
A radiating heater, wherein near infrared radiation of selective emitter of a combustion, heat-exchange and emitter device of the present invention is used to efficiently transfer heat to a radiated surface. Such a radiation heater is particularly advantageous in large volume areas such as fabrication halls, where heating up the entire volume is impossible/inefficient. However direct radiation from the emitter of the combustion, heat-exchange and emitter device of the present invention transfers radiation near infrared directly to the target surface (e.g. skin of a human);
A source of pure water, wherein a condenser unit is configured to recover liquid by condensing vapour in the exhaust gases. In case the fuel is Methanol for example, the condenser unit is laid out for condensing water vapours resulting from combustion of the Methanol; or
A light source, the emitter of the combustion, heat-exchange and emitter device of the present invention being configured to provide (also provide) radiation in visible wavelengths.

### BRIEF DESCRIPTION OF THE DRAWINGS

Further characteristics and advantages of the invention will in the following be described in detail by means of the description and by making reference to the drawings. Which show:

FIG. 1 a schematic cross-section of a first embodiment of the combustion, heat-exchange and emitter device according to the present invention;

FIG. 2A a perspective view of a particularly preferred embodiment of the combustion, heat-exchange and emitter device according to the present invention;

FIG. 2B a cross section of the combustion, heat-exchange and emitter device of FIG. 2A with section plane X;

FIG. 3A a schematic top view of multiple layers of the layered construction of a particularly preferred embodiment of the combustion, heat-exchange and emitter device according to the present invention; and

FIG. 3B a schematic perspective view of multiple layers of the layered construction of the combustion, heat-exchange and emitter device of FIG. 3A.

Note: The figures are not drawn to scale, are provided as illustration only and serve only for better understanding but not for defining the scope of the invention. No limitations of any features of the invention should be implied form these figures.

### DESCRIPTION OF PREFERRED EMBODIMENTS

Certain terms will be used in this patent application, the formulation of which should not be interpreted to be limited by the specific term chosen, but as to relate to the general concept behind the specific term.

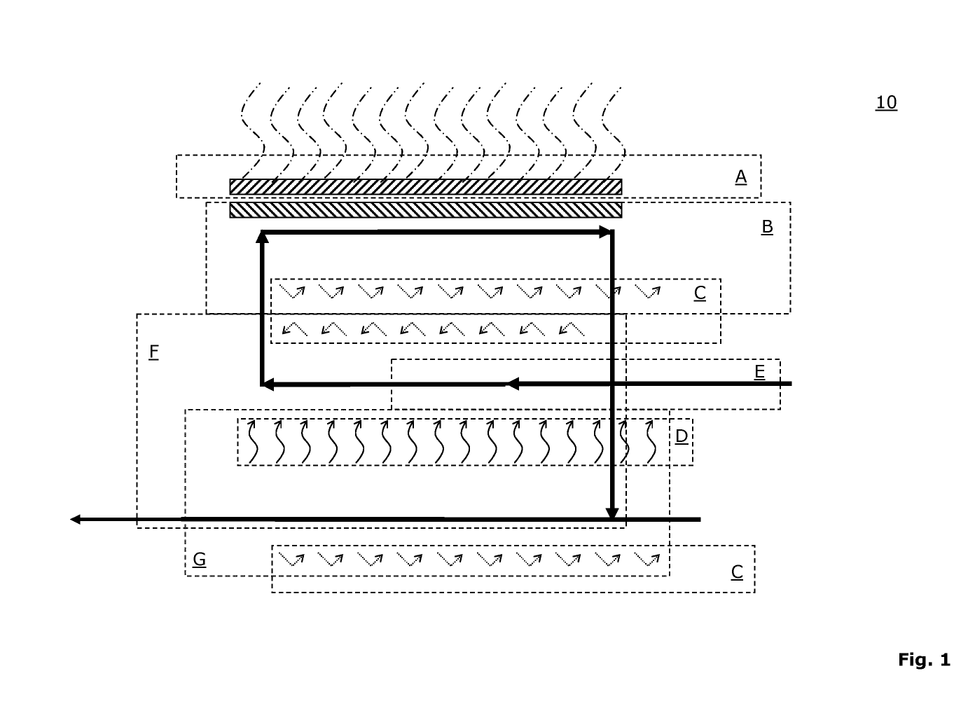

FIG. 1 shows a schematic side representation of a first embodiment of the combustion, heat-exchange and emitter device 10 according to the present invention. As seen on this figure, each of the functions of combustion, heat-exchange and radiation emission are divided into corresponding sections A to G. This allows each section to be optimised for the particular function with little or no restrictions.

### Radiation Emission

The combustion, heat-exchange and emitter device 10 comprises a radiation emitter section A configured for transforming heat from combustion into predominantly near-infrared radiation.

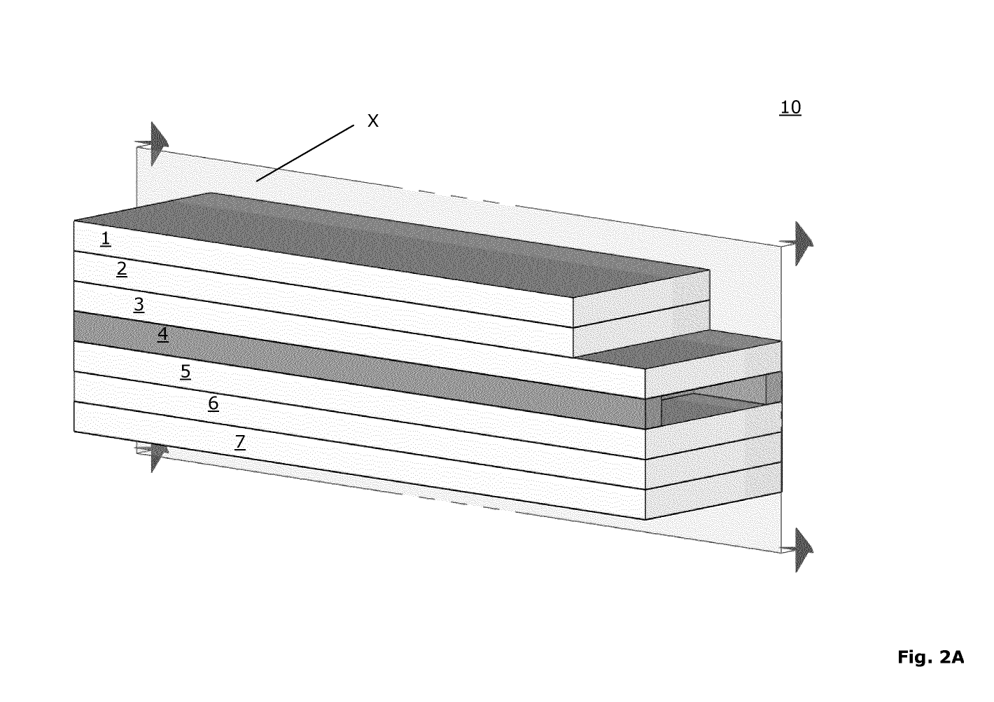

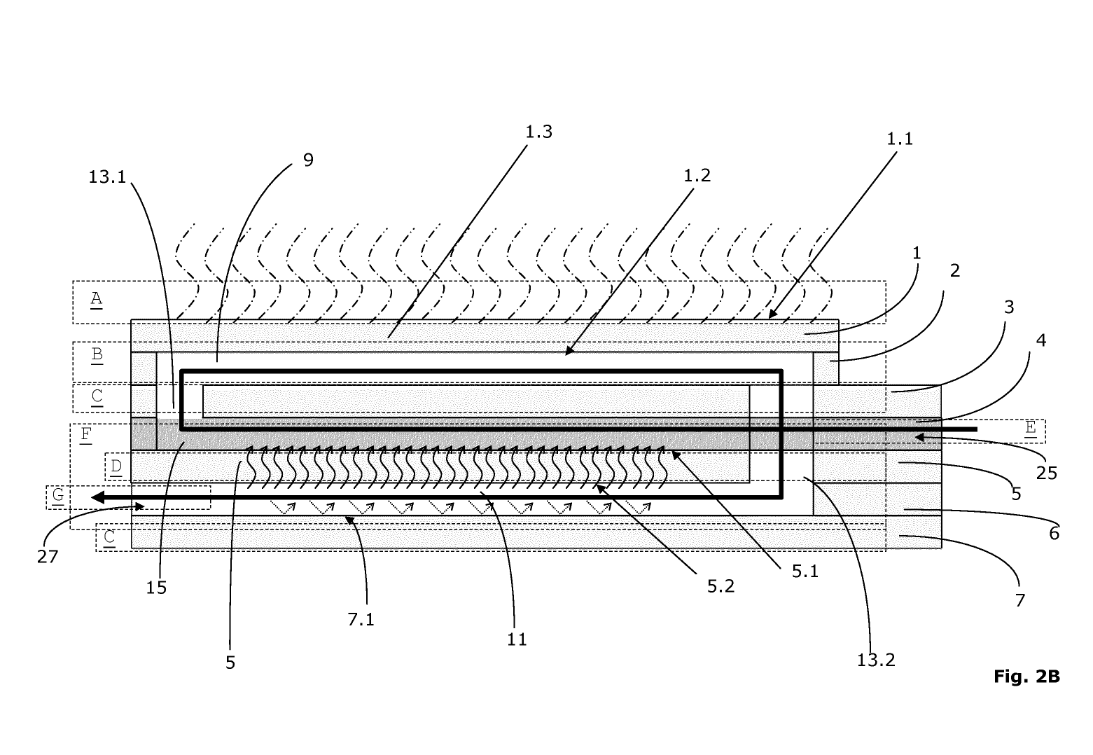

As shown on FIG. 2B, for emitting radiation, the radiation emitter section A comprises a selective emitter 1.3 configured for emitting predominantly near-infrared radiation when heated up to high temperatures. The selective emitter 1.3 is arranged on an outer surface 1.1 facing away from the combustion, heat-exchange and emitter device 10.

In the most preferred embodiments of the combustion, heat-exchange and emitter device 10 according to the present invention, the selective emitter 1.3 comprises a selectively emitting material such as a rare-earth containing layer, preferably an Ytterbium-oxide Yb2O3 or a Platinum emitter layer. Alternatively or in addition, the selective emitter 1.3 comprises a selectively emitting nanostructured layer, such as a photonic crystal comprising temperature-resistant metal or ceramic.

In an even further embodiment, the selective emitter 1.3 comprises an inventive photonic crystal made of a selective emitter material such as e.g. Ytterbium-oxide Yb2O3.

In addition to a selective emitter 1.3, the radiation emitter section A may comprise a spectral shaper, which supports the functions of the selective emitter 1.4 and is:

configured as a band pass filter for a first, optimal spectral band of the radiation emitted by the selective emitter 1.3 when exposed to high temperature; and

configured as a reflector for further, non-optimal spectral band(s) of the radiation emitted by the selective emitter 1.3, so that said second, non-optimal spectral band radiation is recycled as radiation redirected towards the selective emitter 1.3 and/or the conversion section 1.2.

### Combustion

The combustion, heat-exchange and emitter device 10 further comprises a conversion section B arranged adjacent to the radiation emitter section A. The conversion section B comprises e.g. a catalytic coating in order to provide for surface specific fuel combustion to maximize heat transfer between a thermal energy carrier (fuel) and the radiation emitter section A in order to heat up the selective emitter 1.3 to high temperatures. The conversion section B either comprises a material which provides sufficient stability and/or it comprises a substrate made of a high temperature resistant material, preferably a ceramic material coated by a material supporting surface specific fuel combustion processes. The thermal energy carrier (fuel) enters the combustion, heat-exchange and emitter device 10 through an inlet section E connected with the radiation emitter section A.

The fuel is a chemical energy source, wherein the chemical energy carrier is preferably a fossil fuel such as methanol or hydrogen.

As shown on FIG. 2B, within the conversion section B a combustion chamber 9 is defined. The conversion of the chemical energy of the thermal energy carrier (fuel) into heat takes place therefore in this combustion chamber 9 arranged adjacent and thermally connected to the emitter section A.

The selective emitter 1.3 is preferably configured and arranged with respect to the combustion chamber 9 such as to provide an essentially constant radiation over its entire outer surface 1.1 when it is heated up to high temperatures. This ensures an optimal use of the radiation and enables the use of the combustion, heat-exchange and emitter device 10 in a thermophotovoltaic device in a particularly efficient manner enabling homogeneous radiation of the entire surface of a photovoltaic cell.

### Heat Exchange

The third main function of the combustion, heat-exchange and emitter device 10 is provided for by means of a heat recovery section F configured such as to transfer excess heat of the thermal energy carrier from an exhaust outlet section G (after exiting the conversion section B) to the inlet section E such as to pre-heat the thermal energy carrier (fuel) entering the device 10 therethrough. This way the efficiency of the combustion, heat-exchange and emitter device 10 is greatly improved as heat losses are minimised and also the surface specific combustion in the combustion chamber 9 is improved as the fuel is pre-heated in the inlet section E before it enters the conversion section B.

### Heat Management

In order to minimise heat loss outwards the device 10, a heat conduction inhibition section C is provided adjacent to the exhaust outlet section G of the device 10. The heat conduction inhibition section C adjacent the exhaust outlet G allows that a higher proportion of the excess heat of the thermal energy carrier is efficiently used to pre-heat the intake fuel in the inlet section E.

In addition, to prevent heat in the conversion section B to be also transferred to the inlet section E (which would lower the temperature and thus efficiency in the combustion chamber 9), a further heat conduction inhibition section C may be provided between said inlet section E and said conversion section B. This further heat conduction inhibition section C between said inlet section E and said conversion section B preferably comprises heat reflector layers, configured to reflect heat within the conversion section B resp. within the inlet section E. By using reflecting layers in the further heat conduction inhibition section C, energy loss is greatly minimized and unnecessary heating up of the device 10 is prevented as compared to using heat absorbent material.

For conducting excess heat of the thermal energy carrier from the exhaust outlet section G to the inlet section E, a heat conducting section D is provided within the heat recovery section F, between the exhaust outlet section G and the inlet section E.

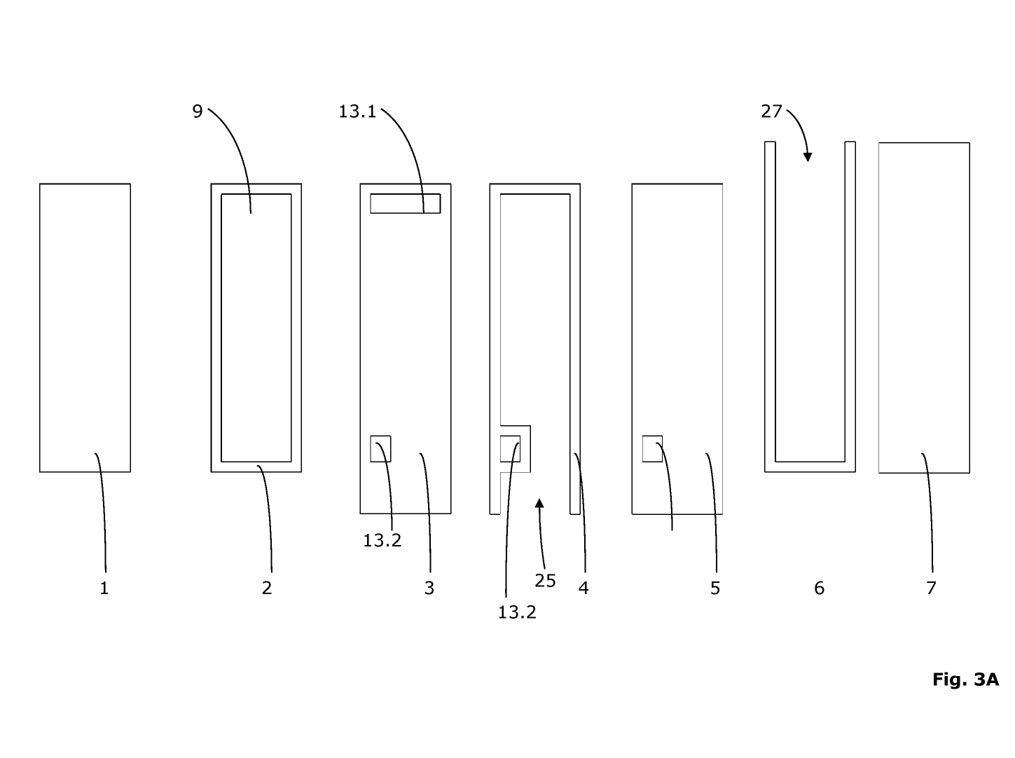

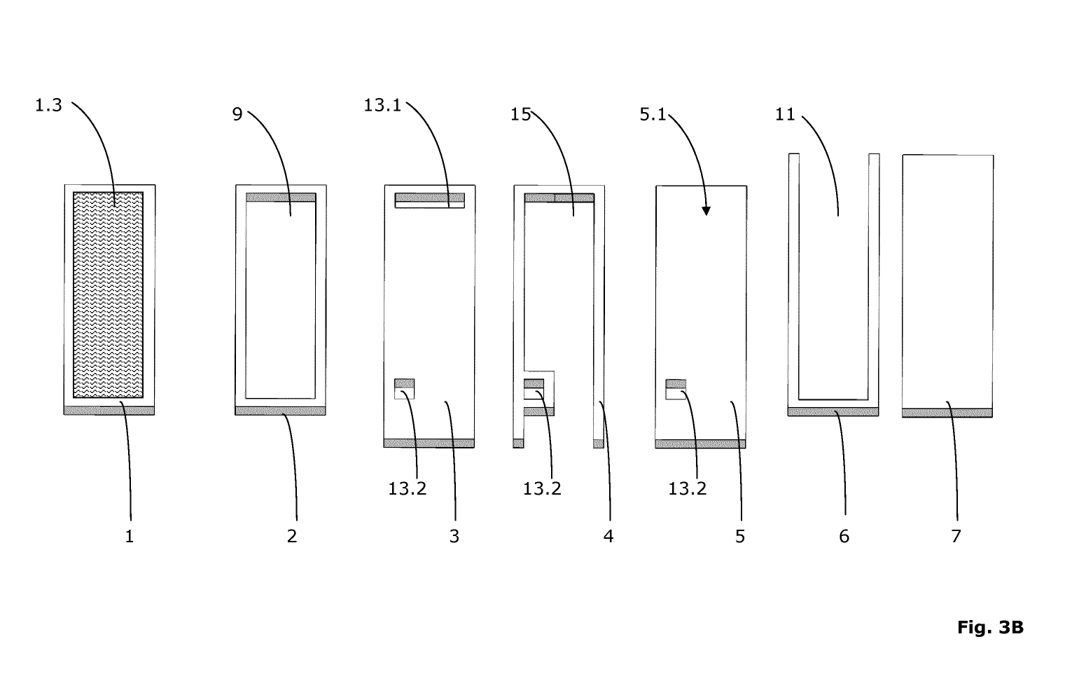

In the following, the advantages of the present invention resulting from separation of the combustion, heat-exchange and emitter functions shall be described referring to a particularly preferred layered construction of the combustion, heat-exchange and emitter device 10 as shown in FIGS. 2A through 3B. Note however, that besides a layered construction, other modular constructions of each section of the combustion, heat-exchange and emitter device 10 can be envisaged without departing from the concept of the present invention.

FIG. 2A shows a perspective view of such a particularly preferred embodiment of the combustion, heat-exchange and emitter device 10 in a layered configuration. This layered configuration enables each layer to be produced independently, each layer being produced to the required precision, standard. This inventive construction of a combustion, heat-exchange and emitter device 10 provides for an essential cost-reduction as only the most complex section(s) (namely the radiation emission section A with the selective emitter 1.3 and the conversion section B with the catalytic coating) can be produced independently from the less technologically demanding sections.

FIG. 2B shows a cross section with section plane X of the combustion, heat-exchange and emitter device 10 of FIG. 2A depicting well its layered construction.

Within the radiation emission section A, an emitter layer 1 having an outer surface 1.1 facing away from the device 10 is provided. The outer surface 1.1 at least partially defines the radiation emission section A whereas its inner surface 1.2 at least partially defines the conversion section B.

Within the conversion section B, a combustion chamber 9 is defined adjacent the inner surface 1.2 of the emitter layer 1.

A heat conduction layer 5 is provided with a heat dissipating surface 5.1 arranged towards said inlet section E and a heat absorbing surface 5.2 arranged towards said exhaust outlet section G, the heat conduction layer 5 at least partially defining the heat recovery section F.

The layered construction of the combustion, heat-exchange and emitter device 10 further comprises a heat conduction inhibition layer 6 adjacent to said exhaust outlet section G arranged to minimise heat loss outwards the device 10.

For providing a space for pre-heating the fuel entering the combustion, heat-exchange and emitter device 10, a pre-heat chamber 15 is defined within the inlet section E of the heat recovery section F, the pre-heat chamber 15 being thermally connected to said heat dissipating surface 5.1.

The pre-heat chamber 15 is connected to the combustion chamber 9 by a first flow-through passage 13.1.

For providing space for the exhaust fuel to transfer its excess heat to the heat absorbing surface 5.2, a heat recovery chamber 11 is defined between the said heat absorbing surface 5.2 and the heat conduction inhibition layer 6 within the exhaust outlet section G of the heat recovery section F.

The combustion chamber 9 is connected with the heat recovery chamber 11 by means of a second flow-through passage 13.2.

As illustratively shown on FIG. 2B (with continuous waving arrows), the heat recovery chamber 11 and the pre-heat chamber 15 are arranged and configured such that heat absorbed by the heat absorbing surface 5.2 is dissipated by the heat dissipating surface 5.1 such as to pre-heat a thermal energy carrier (fuel) within the pre-heat chamber 15.

FIGS. 2A through 3B show a particularly preferred embodiment wherein a combustion layer 2 is provided between the emitter layer 1 and the heat conduction layer 5, for at least partially defining the combustion chamber 9. In addition, a heat conduction inhibition layer 3 is provided between the emitter layer 1 and the heat conduction layer 5, the further heat conduction inhibition layer 3 separating the pre-heat chamber 15 from the combustion chamber 9 and at least partially defining the second flow-through passage 13.2 respectively first flow-through passage 13.1.

A further heat conduction inhibition layer 3 may be provided between the emitter layer 1 and the heat conduction layer 5, the further heat conduction inhibition layer 3 separating the pre-heat chamber 15 from the combustion chamber 9 to prevent heat in the conversion section B to be also transferred to the inlet section E (which would lower the temperature and thus efficiency in the combustion chamber 9). The further heat conduction inhibition layer 3 also at least partially defines the second flow-through passage 13.2 respectively first flow-through passage 13.1.

For at least partially defining the pre-heat chamber 15 and the second flow-through passage 13.2, a pre-heat layer 4 is provided between the emitter layer 1 and the heat conduction layer 5 whereas an output layer 6 is provided between the heat conduction layer 5 and the heat conduction inhibition layer 7 for at least partially defining the heat recovery chamber 11.

As well shown on FIG. 2B, the pre-heat chamber 15, the second flow-through passage 13.2; the combustion chamber 9; the first flow-through passage 13.1 and the heat recovery chamber 11 form a meander-like channel of essentially constant cross-section within the device 10. This provides for an optimal flow of fuel through the device 10 allowing an efficient pre-heating; combustion and exhaust of the fuel, while excess heat is recovered from the exhaust.

Optionally, for reducing heat-loss, the combustion, heat-exchange and emitter device 10 (except for the outer surface 1.1 of the radiation emission section A) may be provided with an insulation layer.

FIGS. 3A and 3B showing a top view respectively a perspective view, depict the layers 1 through 7 of the combustion, heat-exchange and emitter device 10 as provided by the method according to the present invention comprising the steps:

providing an emitter layer 1 having an outer surface 1.1 facing away from the combustion, heat-exchange and emitter device 10 and an inner surface 1.2;

at least partially coating said inner surface 1.2 of the emitter layer 1 with a catalytic coating in order to provide for surface specific fuel combustion;

providing said emitter layer 1 with a selective emitter 1.3 configured for emitting predominantly near-infrared radiation in the direction of said outer surface 1.1 when it is heated up to high temperatures via said inner surface 1.2;

providing a pre-heat layer 4;

joining said emitter layer 1 with the pre-heat layer 4 such as to define a combustion chamber 9 adjacent to the inner surface 1.2 of the emitter layer 1;

providing a heat conduction layer 5 with a heat dissipating surface 5.1 and a heat absorbing surface 5.2;

joining the pre-heat layer 4 and the heat conduction layer 5, such as to define a pre-heat chamber 15 in-between and thermally connect the pre-heat chamber 15 to said heat dissipating surface 5.1;

providing a first flow-through passage 13.1 connecting the pre-heat chamber 15 with the combustion chamber 9;

providing a heat conduction inhibition layer 7;

joining said heat conduction inhibition layer 7 with the heat conduction layer 5 such as to define a heat recovery chamber 11 adjacent to said a heat absorbing surface 5.2; and

providing a second flow-through passage 13.2 connecting the combustion chamber 9 and the heat recovery chamber 11,

The finished construction of the combustion, heat-exchange and emitter device 10 as shown on FIG. 2A after completion of the method of the present invention, the heat recovery chamber 11 and the pre-heat chamber 15 is arranged and configured such that heat absorbed by the heat absorbing surface 5.2 is dissipated by the heat dissipating surface 5.1 such as to pre-heat a thermal energy carrier fuel within the pre-heat chamber 15.

In order to produce the particularly preferred embodiment of the combustion, heat-exchange and emitter device 10 of the present invention as depicted on FIGS. 2A through 3B, the method further comprises the following steps:

providing a combustion layer 2 between the emitter layer 1 and the heat conduction layer 5, configured and arranged to at least partially define said combustion chamber 9;

providing a further heat conduction inhibition layer 3 between the emitter layer 1 and the heat conduction layer 5, the further heat conduction inhibition layer 3 separating said pre-heat chamber 15 from the combustion chamber 9; arranged and configured to at least partially define said second flow-through passage 13.2 and at least partially define said first flow-through passage 13.1; and

providing an output layer 6 between the heat conduction layer 5 and the heat conduction inhibition layer 7, arranged and configured such as to at least partially define the heat recovery chamber 11.

The method for producing the combustion, heat-exchange and emitter device 10 configures and arranges the layers as shown on FIGS. 3A and 3B with respect to each other so that the pre-heat chamber 15, the second flow-through passage 13.2; the combustion chamber 9; the first flow-through passage 13.1; and the heat recovery chamber 11 form a meander-like channel of essentially constant cross-section.

It will be understood that many variations could be adopted based on the specific structure hereinbefore described without departing from the scope of the invention as defined in the following claims.

### REFERENCE LIST

combustion, heat-exchange and emitter device 10
radiation emission section A
(thermal energy to heat) conversion section B
heat conduction inhibition section C
heat conducting section D
(thermal energy carrier) inlet section E
heat recovery section F
exhaust outlet section G
emitter layer 1
outer surface 1.1
inner surface 1.2
selective emitter 1.3
combustion layer 2
further heat conduction inhibition layer 3
pre-heat layer 4
heat conduction layer 5
heat dissipating surface 5.1
heat absorbing surface 5.2
output layer 6
heat conduction inhibition layer 7
heat reflective surface 7.1
combustion chamber 9
heat recovery chamber 11
flow-through passage 13
second flow-through passage 13.2
first flow-through passage 13.1
pre-heat chamber 15
an input opening 25
exit opening 27

What is claimed is:

1. Combustion, heat-exchange and emitter device (10) for converting chemical into electro-magnetic radiation, the device (10) comprising:
a radiation emission section (A) comprising a selective emitter (1.3) configured for emitting predominantly near-infrared radiation when heated up to high temperatures;
a conversion section (B) arranged adjacent to said radiation emission section (A) and preferably comprising a catalytic coating in order to provide for surface specific fuel combustion to maximize heat transfer between a thermal energy carrier (fuel) and the radiation emission section (A);
a heat recovery section (F) configured such as to transfer excess heat of the thermal energy carrier from an exhaust outlet section (G) to an inlet section (E) such as to pre-heat the thermal energy carrier (fuel) entering the device (10) therethrough.

2. Combustion, heat-exchange and emitter device (10) according to claim 1, characterised in that the selective emitter (1.3) comprises a selectively emitting material such as a rare-earth containing layer, preferably an Ytterbium-oxide Yb₂O₃ or Platinum emitter layer.

3. Combustion, heat-exchange and emitter device (10) according to claim 1, characterised in that the selective emitter (1.3) comprises a selectively emitting nanostructured layer, such as a photonic crystal comprising temperature-resistant metal or ceramic.

4. Combustion, heat-exchange and emitter device (10) according to claim 2, characterised in that the selective emitter (1.3) comprises a photonic crystal made of a selective emitter material, preferably of Ytterbium-oxide Yb₂O₃.

5. Combustion, heat-exchange and emitter device (10) according to claim 1, characterised in that the radiation emission section (A) comprises a spectral shaper:
configured as a band pass filter for a first, optimal spectral band of the radiation emitted by the selective emitter (1.3) when exposed to high temperature; and
configured as a reflector for further, non-optimal spectral band(s) of the radiation emitted by the selective emitter (1.3), so that said second, non-optimal spectral band radiation is recycled as radiation redirected towards the selective emitter (1.3) and/or the conversion section (1.2).

6. Combustion, heat-exchange and emitter device (10) according to claim 1,
characterised in that a heat conduction inhibition section (C) is provided:
between said inlet section (E) and said conversion section (B); and/or
adjacent to said exhaust outlet section (G) arranged to minimise heat loss outwards the device (10).

7. Combustion, heat-exchange and emitter device (10) according to claim 1,
characterised in that a heat conducting section (D) is provided between the exhaust outlet section (G) and the inlet section (E) for conducting excess heat of the thermal energy carrier from an exhaust outlet section (G) to the inlet section (E).

8. Combustion, heat-exchange and emitter device (10) according to claim 1,
characterised in that, the device comprises:
within said radiation emission section (A), an emitter layer (1) having an outer surface (1.1) facing away from the device (10) at least partially defining said radiation emission section (A) and an inner surface (1.2) at least partially defining said conversion section (B);
a heat conduction layer (5) with a heat dissipating surface (5.1) arranged towards said inlet section (E) and a heat absorbing surface (5.2) arranged towards said exhaust outlet section (G), the heat conduction layer (5) at least partially defining said heat recovery section (F);
a heat conduction inhibition layer (6) adjacent to said exhaust outlet section (G) arranged to minimise heat loss outwards the device (10);
wherein:
within the conversion section (B), a combustion chamber (9) is defined adjacent the inner surface (1.2) of the emitter layer (1);
a pre-heat chamber (15) is defined within the inlet section (E) of the heat recovery section (F), the pre-heat chamber (15) being thermally connected to said heat dissipating surface (5.1);
a first flow-through passage (13.1) is provided to connect the pre-heat chamber (15) and the combustion chamber (9);
a heat recovery chamber (11) is defined between said heat absorbing surface (5.2) and said heat conduction inhibition layer (6) within the exhaust outlet section (G) of the heat recovery section (F);
a second flow-through passage (13.2) is provided to connect the combustion chamber (9) with the heat recovery chamber (11);
the heat recovery chamber (11) and the pre-heat chamber (15) are arranged and configured such that heat absorbed by the heat absorbing surface (5.2) is dissipated by the heat dissipating surface (5.1) such as to pre-heat a thermal energy carrier (fuel) within the pre-heat chamber (15).

9. Combustion, heat-exchange and emitter device (10) according to claim 8, wherein said emitter layer (1) and the selective emitter (1.3) are configured and arranged with respect to the combustion chamber (9) such as to provide an essentially constant radiation over its entire outer surface (1.1)) when it is heated up to high temperatures.

10. Combustion, heat-exchange and emitter device (10) according to claim 8, further comprising:
a combustion layer (2) between the emitter layer (1) and the heat conduction layer (5), for at least partially defining said combustion chamber (9);
a further heat conduction inhibition layer (3) between the emitter layer (1) and the heat conduction layer (5), the further heat conduction inhibition layer (3) separating said pre-heat chamber (15) from the combustion chamber (9) and at least partially defining said second flow-through passage (13.2) respectively first flow-through passage (13.1); and/or
a pre-heat layer (4) between the emitter layer (1) and the heat conduction layer (5), for at least partially defining said pre-heat chamber (15) and said second flow-through passage (13.2); and/or
an output layer (6) between the heat conduction layer (5) and the heat conduction inhibition layer (7), at least partially defining the heat recovery chamber (11).

11. Combustion, heat-exchange and emitter device (10) according to claim 8, wherein:
said pre-heat chamber (15),
said second flow-through passage (13.2);
said combustion chamber (9);
said first flow-through passage (13.1); and
said heat recovery chamber (11)
form a meander-like channel of essentially constant cross-section within the device (10).

12. Combustion, heat-exchange and emitter device (10) according to claim 8, characterised in that except for the outer surface (1.1) of the radiation emission section (A), the heat-exchange and emitter device (10) is provided with an insulation layer for reducing heat-loss.

13. A thermophotovoltaic device comprising:
a combustion, heat-exchange and emitter device (10) according to claim 1; and
a photovoltaic cell arranged adjacent to said combustion, heat-exchange and emitter device (10) in a radiating direction of its selective emitter (1.3).

14. Method for producing a combustion, heat-exchange and emitter device (10) comprising the steps:
providing an emitter layer (1) having an outer surface (1.1) facing away from the combustion, heat-exchange and emitter device (10) and an inner surface (1.2);
at least partially coating said inner surface (1.2) of the emitter layer (1) with a catalytic coating in order to provide for surface specific fuel combustion;
providing said emitter layer (1) with a selective emitter (1.3) configured for emitting predominantly near-infrared radiation in the direction of said outer surface (1.1) when it is heated up to high temperatures via said inner surface (1.2);
providing a pre-heat layer (4);
joining said emitter layer (1) with the pre-heat layer (4) such as to define a combustion chamber (9) adjacent to the inner surface (1.2) of the emitter layer (1);
providing a heat conduction layer (5) with a heat dissipating surface (5.1) and a heat absorbing surface (5.2);
joining the pre-heat layer (4) and the heat conduction layer (5), such as to define a pre-heat chamber (15) in-between and thermally connect the pre-heat chamber (15) to said heat dissipating surface (5.1);
providing a first flow-through passage (13.1) connecting the pre-heat chamber (15) with the combustion chamber (9);
providing a heat conduction inhibition layer (7);
joining said heat conduction inhibition layer (7) with the heat conduction layer (5) such as to define a heat recovery chamber (11) adjacent to said a heat absorbing surface (5.2); and
providing a second flow-through passage (13.2) connecting the combustion chamber (9) and the heat recovery chamber (11),
the heat recovery chamber (11) and the pre-heat chamber (15) being arranged and configured such that heat absorbed by the heat absorbing surface (5.2) is dissipated by the heat dissipating surface (5.1) such as to pre-heat a thermal energy carrier (fuel) within the pre-heat chamber (15).

15. Method for producing a combustion, heat-exchange and emitter device (10) according to claim 14, characterised in that the selective emitter (1.3) is provided so as to comprise a selectively emitting material such as a rare-earth containing layer, preferably an Ytterbium-oxide Yb₂O₃ or Platinum emitter layer.

16. Method for producing a combustion, heat-exchange and emitter device (10) according to claim 14, characterised in that a selectively emitting nanostructured layer, such as a photonic crystal comprising temperature-resistant metal or ceramic is provided as the selective emitter (1.3).

17. Method for producing a combustion, heat-exchange and emitter device (10) according to claim 14, characterised in that a photonic crystal of Ytterbium-oxide Yb₂O₃ is provided as the selective emitter (1.3).

18. Method for producing a combustion, heat-exchange and emitter device (10) according to claim 14, wherein said emitter layer (1) and the selective emitter (1.3) are configured and arranged with respect to the combustion chamber (9) such as to provide an essentially constant radiation over its entire outer surface (1.1) when it is heated up to high temperatures.

19. Method for producing a combustion, heat-exchange and emitter device (10) according to claim 14, further comprising one or more of the following steps:
providing a combustion layer (2) between the emitter layer (1) and the heat conduction layer (5), configured and arranged to at least partially define said combustion chamber (9);
providing a further heat conduction inhibition layer (3) between the emitter layer (1) and the heat conduction layer (5), the further heat conduction inhibition layer (3) separating said pre-heat chamber (15) from the combustion chamber (9);
arranged and configured to at least partially define said second flow-through passage (13.2) and at least partially define said first flow-through passage (13.1); and/or
providing an output layer (6) between the heat conduction layer (5) and the heat conduction inhibition layer (7), arranged and configured such as to at least partially define the heat recovery chamber (11).

20. Method for producing a combustion, heat-exchange and emitter device (10) according to claim 14, wherein:
said pre-heat chamber (15),
said second flow-through passage (13.2);
said combustion chamber (9);
said first flow-through passage (13.1); and
said heat recovery chamber (11)
are configured and arranged with respect to each other so as to form a meander-like channel of essentially constant cross-section.
